(19) United States
(12) Patent Application Publication
(10) Pub. No.: US 2026/0346657 A1
(43) Pub. Date: Nov. 5, 2026

(54) TIRE INSERT HAVING A PROGRESSIVELY VARIABLE DENSITY

(71) Applicant: Jeffrey P. Douglas, San Clemente, CA (US)

(72) Inventor: Jeffrey P. Douglas, San Clemente, CA (US)

(21) Appl. No.: 19/197,711

(22) Filed: May 2, 2025

(51) Int. Cl. B60C 17/06; B60C 7/10

(52) U.S. Cl. CPC B60C 17/065; B60C 7/1015; B60C 2200/10

(57) ABSTRACT

An insert having a cross-section with a progressively variable density is disclosed to replace a conventional inner tube for a tire of the kind typically used by a motorcycle. According to one embodiment, the insert has a series of initially straight and flexible (e.g., foam) insert segments that are bent to assume a curved configuration that conforms to the shape of the tire. The curved insert segments are pressed one at a time into the tire. With the insert installed, the insert segments are aligned end-to-end one against the next such that the insert extends continuously around the tire to lie against the crown and between the sidewalls. By virtue of the series of flexible insert segments being bent, the density of the segments is greater adjacent the rim of the wheel than adjacent the crown of the tire to enhance sidewall stability and traction between the tire and the road.

### BACKGROUND OF THE INVENTION

### 1. Field of the Invention

This invention relates to a progressively variable density (e.g., foam) insert to be installed within a tire to replace an inflatable inner tube. In a first embodiment, the improved insert includes a series of initially straight and uniform density foam insert segments that are first bent so as to have a curved configuration and then pushed one at a time into end-to-end alignment within the tire so as to lie between the crown of the tire and the rim of a wheel on which the tire is mounted. In a second embodiment, the tire insert includes a single initially straight and uniform density foam insert segment that is bent to have a curved configuration so that the opposite ends thereof lie one adjacent the other.

### 2. Background Art

Tires have long been used which include inflatable inner tubes to cushion one's ride. Such inner tube type tires are often found on motorcycles. However, the inner tube is susceptible to being punctured by a nail, a sharp stone, or other obstacles that are encountered along a roadway. In this case, the tire will go flat which requires that it be repaired or replaced. To overcome this problem, it is known to replace the conventional inner tube with a solid tire insert that is manufactured from a continuous piece of toroid shaped molded foam. The foam insert typically has a donut or toroidal shape with a uniform density throughout.

The conventional continuously extending (i.e., endless) donut-shaped foam insert usually has to be forced into surrounding engagement inside a tire. Because of its one-piece continuous construction, it is sometimes difficult to install the insert, such that the insert must be wrestled into place within the tire. What is more, the conventional one-piece continuously extending tire insert is often large and bulky which also makes it difficult to store in a small area and ship in a compact container.

Accordingly, what would therefore be desirable is an improved insert for a tire to replace an inner tube, wherein the insert would be easier to install inside the tire and would have a cross-section with progressively variable density around its circumference between the rim of a wheel and the crown of the tire to provide the tire with sidewall stability and a more comfortable ride regardless of the road surface.

### SUMMARY OF THE INVENTION

In general terms, an improved progressively variable density solid insert is disclosed to be installed within a tire to replace an inflatable inner tube of the kind often used in a motorcycle tire. Rather than a continuously extending (i.e., endless) one-piece insert having a donut or toroidal shape that requires a significant force to be press-fit within the tire, the improved insert according to a first embodiment is formed by a series of initially straight and uniform density insert segments that are manufactured from a resilient (e.g., closed cell foam) material. Each segment has a flexible characteristic so as to be capable of being bent to assume a curved configuration and thereby conform to the shape of the tire within which the insert will be installed.

A series of the straight insert segments are first bent and then pushed one at a time into receipt by the tire to be aligned end-to-end one another around the circumference of the tire and positioned between the crown of the tire and the rim of a wheel on which the tire is mounted. Because each one of the series of insert segments is bent and curved during its installation, the density of the insert segments will be greater (i.e., firmer) at the inside of the curve that lies adjacent the rim and conversely less dense at the outside of the curve that lies adjacent the crown of the tire. By virtue of the insert segments having a cross-section with a progressively variable density, the tire is provided with enhanced stability in the lower sidewalls to produce a more comfortable ride.

### BRIEF DESCRIPTION OF THE DRAWINGS

FIG. 1 shows a series of initially straight and flexible insert segments with a uniform density that will be bent and aligned end-to-end to form an improved solid and progressively variable density tire insert according to a first embodiment of this invention;

FIG. 2 is a cross-section taken along lines 2-2 of FIG. 1 to illustrate the uniform density of one of the initially straight insert tire segments;

FIG. 3 illustrates the series of initially straight and flexible tire insert segments of FIG. 1 after being bent and aligned end-to-end to form the tire insert having a toroidal configuration with a progressively variable density for installation within a tire;

FIG. 4 is a cross-section of one of the series of tire insert segments taken along lines 4-4 of FIG. 3 after being bent to illustrate the progressively variable density thereof;

FIG. 5 is a cross-section of another one of the series of tire insert segments taken along lines 5-5 of FIG. 3 after being bent to illustrate the progressively variable density thereof;

FIG. 6 shows one of the series of tire insert segments of the tire insert of FIG. 3 after being aligned end-to-end and being compressed from each end between adjacent insert segments such that the cross section volume expands;

FIG. 7 shows an initially straight and flexible tire insert segment after it has been bent into a toroidal configuration to form a one-piece progressively variable density tire insert according to a second embodiment of this invention;

FIG. 8 is a cross section to illustrate the progressively variable density of the one-piece tire insert of FIG. 7;

FIG. 9 is a cross-section of the one-piece progressively variable density tire insert of FIG. 7 after it has been bent and installed within a tire that is mounted on the rim of a wheel;

FIG. 10 shows a modification to the initially straight and flexible tire insert segment which forms the one-piece tire insert of FIG. 7 with a series of triangular voids being located therein prior to it being bent into a toroidal configuration;

FIG. 11 shows the modified tire insert segment of the one-piece tire insert of FIG. 10 after it has been bent into a toroidal configuration to be installed within a tire; and

FIG. 12 shows one of a series of initially curved insert segments that are bent to be aligned end-to-end to form a tire insert having a uniform density.

### DESCRIPTION OF THE PREFERRED EMBODIMENT

To overcome the problems described above that are inherent with a conventional one-piece tire insert, an improved tire insert is disclosed herein. Rather than being manufactured from a continuous (i.e., endless) donut or toroidal shaped material, with a uniform density the improved tire insert is manufactured (e.g., molded) according to a first embodiment of this invention from a series of initially straight insert segments that are preferably made from a closed cell foam (e.g., mousse) or other resilient material so as to have a flexible characteristic and a uniform density. By virtue of its multiple short straight segments, the tire insert of this embodiment can be efficiently stored and shipped in relatively compact packages with lower shipping costs when compared with a conventional larger continuous toroidal insert.

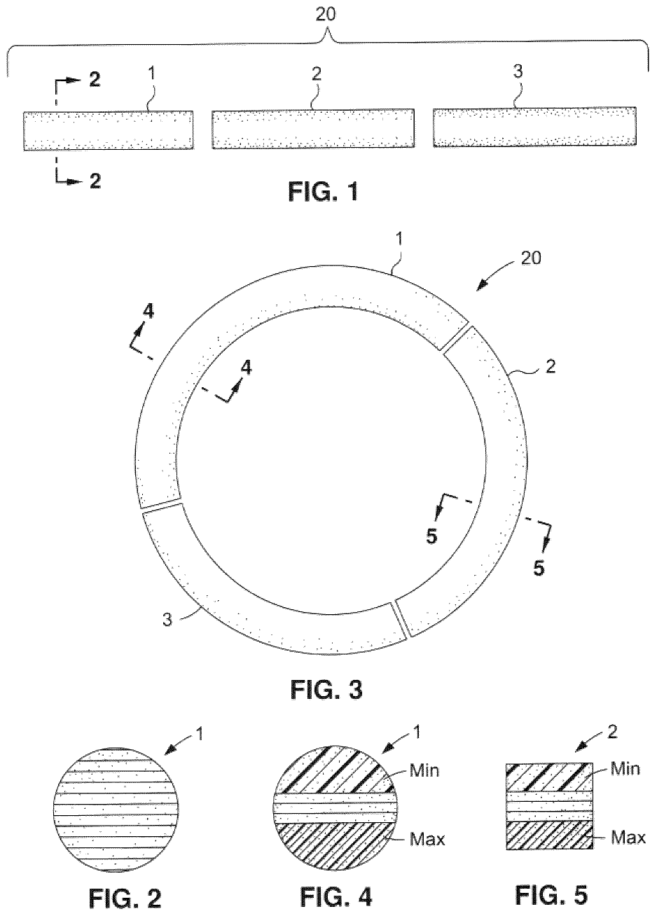

FIG. 1 of the drawings shows a series of initially straight and flexible foam insert segments 1, 2 and 3, each of which having a uniform density as represented in FIG. 2. As will now be described, the initially straight and uniform density insert segments 1-3 are manipulated to form a segmented toroidal tire insert (designated 20 and best shown in FIG. 3) having a progressively variable density. Although three initially straight tire insert segments 1-3 are shown in FIG. 1, it is to be understood that the number of tire insert segments is not to be regarded as a limitation of this invention and will depend largely upon the size of the tire in which the insert will be installed. Each of the tire insert segments 1-3 can, for example, have either a circular cross-section as shown in FIG. 4 or a square cross-section as shown in FIG. 5.

Because of their flexible characteristic, the initially straight and uniform density foam tire insert segments 1-3 of FIG. 1 are adapted to be bent and curved to assume the toroidal configuration shown in FIG. 3 of the drawings so as to conform to the shape of a tire like that designated 46 in FIG. 9 in which the insert will be installed. In their curved configuration of FIG. 3, the insert segments 1-3 of insert 20 lie end-to-end so as to butt one against the other and hug the sidewalls of the tire. In this regard, the individual insert segments 1-3 can be more easily pressed by hand more easily one at a time against the crown of the tire so as to be compressed inside the tire to establish the toroidal insert 20 that extends completely around the circumference thereof. However, the force and the effort required to install the segmented tire insert 20 of this embodiment will typically be much less than that required to install the conventional toroidal shaped continuous tire insert.

What is more, by virtue of bending the series of initially straight tire insert segments 1-3 into curved tire insert segments to form the segmented toroidal tire insert 20 of FIG. 2, the initial uniform density of each straight foam segment will change to have a cross-section that is progressively variable once the insert 20 is installed within the tire and the tire is mounted on the rim of a wheel like that shown in FIG. 9. More particularly as illustrated in FIGS. 4 and 5, the density of each curved insert segment 1-3 will be increased at the inside of the curve that lies on the rim due to the foam being compressed from being bent, while the density of each insert segment will be lessened at the outside of the curve that lies adjacent to the crown of the tire due to the walls of the micro cells being stretched making them thinner and the cells larger. The initial density of the insert segments at their centers will remain relatively unchanged following the bending thereof. What is more, being able to bend and compress each of the individual tire segments 1-3 permits additional foam material to be forced into the tire to provide an overall firmer and adjustable ride unlike that available from an insert having a continuous toroidal shape.

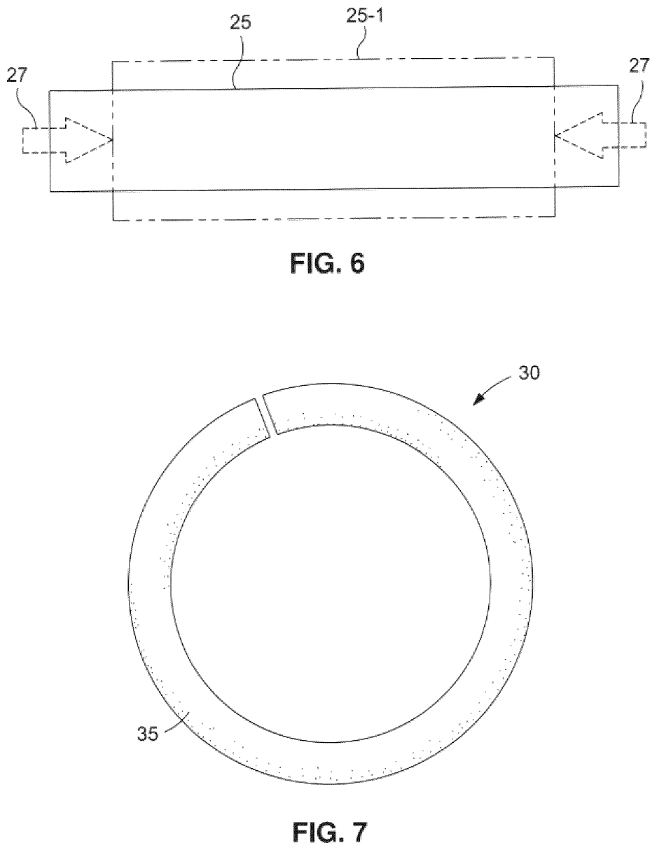

That is to say, and referring to FIG. 6 of the drawings, when the series of tire insert segments 1-3 are inserted around the circumference of the tire between the side walls and against the crown, the segments are positioned to lie in end-to-end alignment and butt one against the other. As represented in FIG. 6, each insert segment 25 is initially sized to be subjected to pressure or a squeezing force at the opposite ends thereof (represented by the arrows 27) so as to be compressed between adjacent segments. Accordingly, the initial cross section or girth of each tire segment (designated 25-1 and shown in broken lines) expands, the initial length is reduced, and the initial density is increased. By virtue of the foregoing and as was pointed out immediately above, additional insert segments can be forced into the tire to increase the overall volume and foam density to thereby provide a firmer feel and allow a greater range of fitment in a greater range of tire sizes.

The variable and increasing density of the curved insert segments 1-3 from the crown of the tire towards the rim of the wheel also provides the rider with the advantage of having a plusher ride feel. Moreover, the relatively high density and firmness of the foam insert segments lying against the rim provides a correspondingly greater stability in the lower sidewalls of the tire within which the insert 20 is installed. Likewise, the insert will be softer at the crown of the tire to create enhanced traction between the tire and the road and a more comfortable ride. When it is installed in the manner shown in FIG. 9, the segmented tire insert 20 of this embodiment also permits the insert to be easily removed from the tire should it become necessary for repair or replacement of the tire.

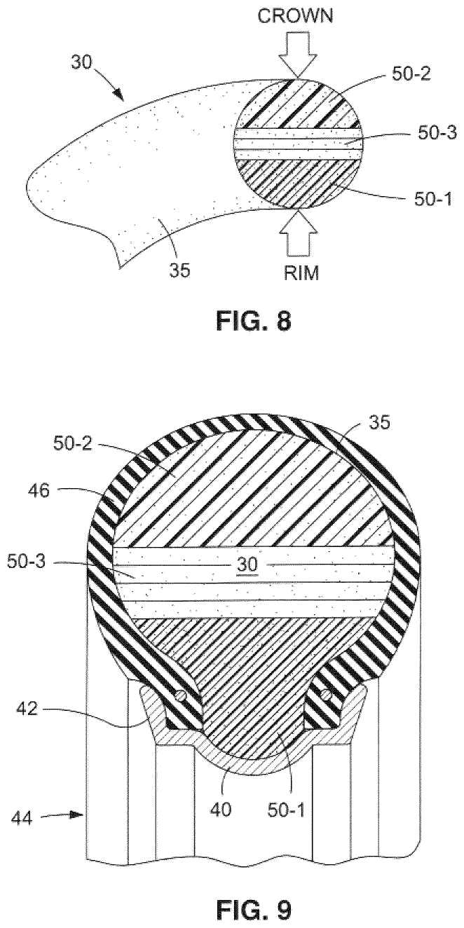

According to a second embodiment of this invention, the plurality of tire insert segments 1-3 of the tire insert 20 of FIGS. 1-5 are replaced by a tire insert 30 having a single relatively long tire insert segment 35 as shown in FIGS. 7-9 of the drawings. As in the case of tire segments 1-3, the single tire insert segment 35 is ideally manufactured (e.g., molded) from a closed cell foam (e.g., mousse) or other reliant material so as to have a flexible characteristic and a uniform density. The tire insert segment 35 is initially a straight segment having a circular cross section and a length that will depend on the size of the tire in which the insert 30 will be installed.

As is best shown in FIG. 7, the initially straight and flexible uniform density tire insert segment 35 of the one-piece insert 30 is adapted to be bent and curved such that the opposite ends thereof lie end-to-end one against the other. FIG. 9 shows the one-piece tire insert 30 having a toroidal configuration and lying in the beadwell 40 of and extending continuously around the rim 42 of a wheel 44 such that the insert 30 conforms to the shape of the tire 46 within which it is installed. As in the case of the tire insert 20 of FIG. 3, the tire insert segment 35 of insert 30 of FIG. 8 can be pressed by hand into the tire 46 between the side walls thereof.

By bending the initially straight and uniform density tire insert segment 35 to fit within the tire 46, the segment is compressed so as to now have a progressively variable cross-section. Referring particularly in this regard to FIGS. 8 and 9, the density of the curved insert 30 will be maximized at the inside of the curve (designated by reference number 50-1) that lays on the rim 42. Moreover, the density of the curved insert 30 will be minimized at the outside of the curve (designated by reference numeral 50-2) that lies adjacent to the crown of the tire 46. However, the intermediate density of the curved insert 30 that is located between the inside 50-1 and the outside 50-2 of the curve (designated by reference numeral 50-3) will remain largely unchanged from the density of the insert prior to it being bent. Accordingly, the tire insert 30 will be softer around the periphery of the crown of the tire 46 and harder (i.e., firmer) around the periphery of the rim 42 of the wheel 44.

Like the segmented insert 20 shown in FIGS. 1-5, the density of the curved insert segment 35 of the one-piece insert 30 of FIGS. 7-9 increases from the crown of the tire 46 towards the rim 42 of the wheel 44 to provide the rider with the advantage of a plusher ride feel. Likewise, the relatively high density and firmness of the foam insert 30 lying against the rim 42 provides a correspondingly greater stability in the lower side walls of the tire 46 within which the insert 30 is installed. Accordingly, the insert 30 will be softer at the crown of the tire 46 to create enhanced traction between the tire and the road and a more comfortable ride. Following installation in the manner shown in FIG. 9 its one-piece construction enables the insert 30 of this embodiment to be relatively easily removed from the tire 46 should removal thereof become necessary.

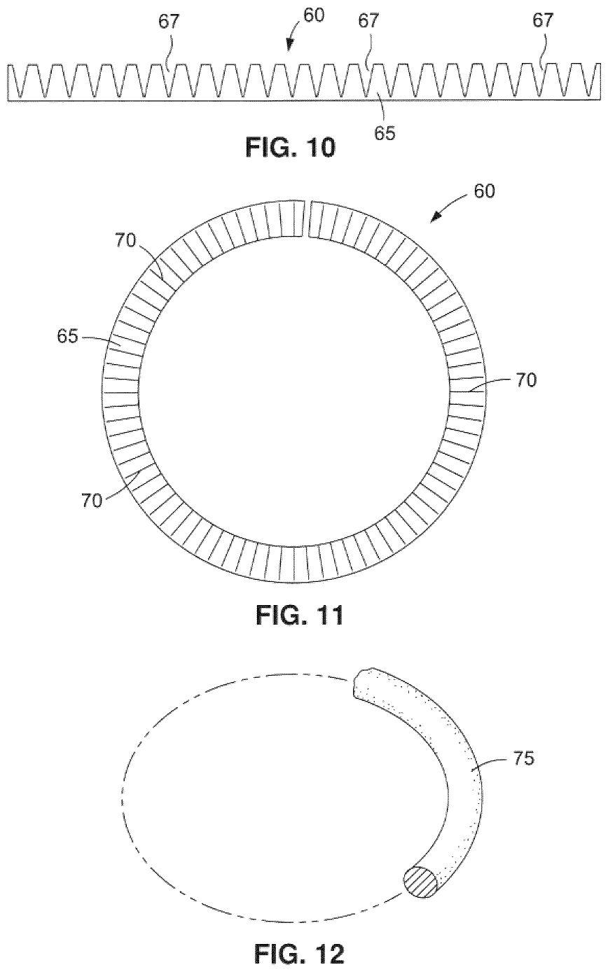

FIGS. 10 and 11 of the drawings show a modification to the one-piece tire insert that is shown in FIGS. 7-9. More particularly, rather than the toroidal tire insert 30 of FIG. 7 having a continuously circular cross section, FIG. 11 shows a one-piece tire insert 60 having an insert segment 65 with a series of triangular (i.e., pie shaped) gaps or voids 67 lying side-by-side one another and being cut out therefrom or molded therewithin. When the tire insert 60 is bent and curved as shown in FIG. 11 to fill a tire like that designated 46 and FIG. 9, the insert 60 is compressed and the pie-shaped voids 67 that are initially missing from the insert segment 65 will automatically be closed so as to create abutments 70 that fill the voids 67 and eliminate the progressively variable density feature that is provided by the tire insert 30. Thus, the one-piece tire insert 60 of FIGS. 10 and 11 will be ideal for one who does not wish to have a progressive stiffness feel in a tire. Despite its ideal one-piece construction as shown in FIGS. 10 and 11, it is within the scope of this embodiment to sever the segment 65 of tire insert 60 to create a series of segments (not shown) and thereby facilitate an efficient storage and shipment.

FIG. 1. of the drawings shows a series of straight and initially uniform density tire insert segments 1-3 that are bent to form a segmented tire insert 20 of FIG. 3 having a progressively variable density. FIG. 12 of the drawing shows an alternate embodiment of this invention where each of a series of initially curved tire inserts segments, only one of which (designated 75) being shown, is molded so as to have a bent shape and a uniform non-progressive density. The series of curved uniform density tire insert segments including segment 75 of FIG. 12 are arranged end-to-end for installation within a tire similar to that shown in FIG. 3.

1. An insert for receipt within a tire to be mounted on a rim of a wheel of a vehicle, wherein the tire has a crown at the outside and sidewalls depending from the crown towards the center of the tire, and wherein said insert comprises a series of insert segments that are aligned end-to-end and butt one against the other so as to extend continuously around the circumference of the tire and lie between the sidewalls and against the crown thereof, each of said series of insert segments being initially straight and manufactured from a flexible material having a completely solid cross section with an identical and uniform density throughout so as to be capable of being compressed to conform to the shape of the tire when said insert is received within the tire.

2. (canceled)

3. (canceled)

4. The insert recited in claim 1, wherein each of the series of initially straight and flexible insert segments of said insert is manufactured from a foam material so as to be compressed when said insert is received within the tire.

5. The insert recited in claim 1, wherein each initially straight insert segment of the series of flexible insert segments of said insert is adapted to be bent and thereby configured for receipt within the tire between the crown of the tire and the rim of the wheel at which to have a variable density.

6. The insert recited in claim 5, wherein each insert segment of the series of flexible insert segments of said insert is curved within the tire so as to have a density that is greater at the rim of the wheel and less dense at the crown of the tire after said series of insert are received within the tire.

7. A one-piece insert for receipt within a tire to be mounted on a rim of a wheel of a vehicle wherein the tire has a crown at the outside and side walls depending from the crown towards the center of the tire, said insert comprising a single flexible insert segment having first and opposite ends and being adapted to bend so as to conform to the shape of the tire such that the first and opposite ends of said single flexible insert segment lie end-to-end one another when the insert is received within the tire at which to lie between the sidewalls and against the crown thereof.

8. The one-piece insert recited in claim 7, wherein the single flexible insert segment of said insert is manufactured from a foam material so as to be compressed when said insert is received within the tire.

9. The one-piece insert recited in claim 7, wherein the single flexible insert segment of said insert is initially straight prior to being bent to conform to the shape of the tire such that said insert is received within the tire between the crown of the tire and the rim of the wheel.

10. The one-piece insert recited in claim 9, wherein the single initially straight flexible insert segment of said insert is bent during its receipt by the tire so as to have a density that is greater at the rim of the wheel than at the crown of the tire.

11. The one-piece insert recited in claim 7, wherein the single flexible insert segment of said insert has a series of triangular voids formed therein and lying side-by-side one another.

12. A method for making an insert for a tire of a vehicle, wherein the tire has a crown at the outside and side walls depending from the crown towards the center of the tire, said method comprising the steps of:
forming a series of initially straight tire insert segments from a flexible material, each of which having first and opposite ends and an initial length, an initial density and an initial cross section; and
inserting said series of initially straight and flexible tire insert segments within the tire so as to lie between the sidewalls thereof such that said series of tire insert segments are bent and lie in end-to-end alignment in order to butt one against the other and create pressure for causing said tire insert segments to be compressed between said first and opposite ends thereof, whereby the initial density is increased, the initial cross section expands, and the initial length of each of said series of tire insert segments is reduced, so that the volume of the flexible material from said series of tire insert segments lying within the tire is adjustable depending upon the pressure that is created when said series of tire insert segments butt one against the other.

13. The method recited in claim 12, including the additional step of forming each of said series of initially straight and flexible tire insert segments from a foam material, such that the volume of the foam material within the tire is adjusted depending upon the pressure that is created when said series of tire insert segments butt one against the other.

14. The method recited in claim 12, including the additional step of inserting said series of initially straight and flexible tire insert segments within the tire as to extend continuously around the circumference of the tire and lie against the crown and the sidewalls thereof.

15. The method recited in claim 12, including the additional step of pressing said series of initially straight and flexible tire insert segments by hand one at a time within the tire so as to lie end-to-end and butt one against the other.
